(19) United States
(12) Patent Application Publication
(10) Pub. No.: US 2025/0196717 A1
(43) Pub. Date: Jun. 19, 2025

(54) ACTIVE BATTERY STATE-OF-CHARGE BALANCING

(71) Applicant: GM GLOBAL TECHNOLOGY OPERATIONS LLC, Detroit, MI (US)

(72) Inventors: Yue-Yun Wang, Troy, MI (US); Lei Hao, Troy, MI (US)

(73) Assignee: GM GLOBAL TECHNOLOGY OPERATIONS LLC, Detroit, MI (US)

(21) Appl. No.: 18/545,185

(22) Filed: Dec. 19, 2023

(51) Int. Cl. B60L 58/22; B60L 58/12

(52) U.S. Cl. CPC B60L 58/22; B60L 58/12; B60L 2210/10

(57) ABSTRACT

A rechargeable energy storage system includes a DC-to-DC converter operational to: receive a battery discharge power at two first local nodes; and convert the battery discharge power to a pack discharge power at two first inter-assembly nodes while in a discharge mode in response to a control signal. The DC-to-DC converter is further operational to: receive a pack charge power at the two first inter-assembly nodes; and convert the pack charge power to a battery charge power at the two first local nodes while in a charge mode. A first battery assembly has a first state-of-charge. A second battery assembly has a second state-of-charge, and operates in series with the first battery assembly. The controller is operational to generate the control signal that varies the DC-to-DC converter to balance the first state-of-charge with the second state-of-charge while in the discharge mode.

### INTRODUCTION

The present disclosure relates to a system and a method for active state-of-charge balancing.

Battery packs in consumer automobiles include battery modules connected in series. As the battery modules discharge, some battery modules may reach a discharged state that prevents electrical power in non-discharged battery modules from being fully utilized. The different states-of-charge among the battery modules is usually due to differences in battery module storage capacities. The different storage capacities are due to differences in sizes, ages and/or mixed chemistries.

Accordingly, those skilled in the art continue with research and development efforts in the field of battery assembly state-of-charge balancing to extend the usefulness of the battery packs.

### SUMMARY

A rechargeable energy storage system is provided herein. The rechargeable energy storage system includes a first DC-to-DC converter, a first battery assembly, a second battery assembly, and a first controller. The first DC-to-DC converter has two first local nodes and two first inter-assembly nodes. The first DC-to-DC converter is operational to: receive a first battery discharge power at the two first local nodes; convert the first battery discharge power to a pack discharge power that is presented at the two first inter-assembly nodes while in a discharge mode. The conversion of the first battery discharge power to the pack discharge power varies in response to a first control signal. The first DC-to-DC converter is further operational to: receive a pack charge power at the two first inter-assembly nodes; and convert the pack charge power to a first battery charge power that is presented from the two first local nodes while in a charge mode. The first battery assembly has a first state-of-charge and is wired directly to the two first local nodes. The second battery assembly has a second state-of-charge, is in communication with one of the two first inter-assembly nodes, and operates in series with the first battery assembly. The first controller is in communication with the first DC-to-DC converter and is operational to generate the first control signal that varies the first DC-to-DC converter to balance the first state-of-charge with the second state-of-charge while in the discharge mode.

In one or more embodiments, the rechargeable energy storage system includes a second DC-to-DC converter, a third battery assembly, and a second controller. The second DC-to-DC converter has two second local nodes and two second inter-assembly nodes. The second DC-to-DC converter is operational to receive a second battery discharge power at the two second local nodes. The second battery assembly is wired directly to the two second local nodes. The second DC-to-DC converter is further operational to convert the second battery discharge power to the pack discharge power that is presented at the two second inter-assembly nodes while in the discharge mode. The conversion of the second battery discharge power to the pack discharge power varies in response to a second control signal. The second DC-to-DC converter is further operational to: receive the pack charge power at the two second inter-assembly nodes; and convert the pack charge power to a second battery charge power that is presented from the two second local nodes while in the charge mode. The third battery assembly has a third state-of-charge, is in communication with one of the two second inter-assembly nodes, and operates in series with the second battery assembly. The second controller is in communication with the second DC-to-DC converter and is operational to generate the second control signal that varies the second DC-to-DC converter to balance the second state-of-charge with the third state-of-charge while in the discharge mode.

In one or more embodiments, the rechargeable energy storage system includes a first adaptation module in communication with the first battery assembly, the second battery assembly, and the first DC-to-DC converter. The first adaptation module is operational to: measure the first state-of-charge of the first battery assembly; measure the second state-of-charge of the second battery assembly; and generate a first target parameter based on the first state-of-charge and the second state-of-charge. The first controller is further operational to vary the first DC-to-DC converter in further response to the first target parameter.

In one or more embodiments of the rechargeable energy storage system, the first controller is further operational to: measure a feedback voltage at one of the two first inter-assembly nodes; and vary the first DC-to-DC converter in further response to the feedback voltage. The first target parameter is a voltage.

In one or more embodiments of the rechargeable energy storage system, the first controller is further operational to: measure a feedback current flowing from the first battery assembly to the first DC-to-DC converter; and vary the first DC-to-DC converter in further response to the feedback current. The first target parameter is a current.

In one or more embodiments of the rechargeable energy storage system, the first adaptation module is further operational to generate the first target parameter with a model predictive control technique based on the first state-of-charge and the second state-of-charge.

In one or more embodiments of the rechargeable energy storage system, the first battery assembly has a different storage capacity than the second battery assembly.

In one or more embodiments of the rechargeable energy storage system, the first battery assembly has a different chemistry than the second battery assembly.

In one or more embodiments of the rechargeable energy storage system, the first battery assembly and the second battery assembly form part of a vehicle.

A method for active battery state-of-charge balancing is provided herein. The method includes receiving a first battery discharge power from a first battery assembly at two first local nodes of a first DC-to-DC converter. The first battery assembly has a first state-of-charge and is wired directly to the two first local nodes. The method includes converting the first battery discharge power to a pack discharge power that is presented at two first inter-assembly nodes of the first DC-to-DC converter while in a discharge mode. One of the two first inter-assembly nodes is in communication with a second battery assembly. The second battery assembly has a second state-of-charge. The second battery assembly operates in series with the first battery assembly. The converting of the first battery discharge power to the pack discharge power varies in response to a first control signal. The method further includes receiving a pack charge power at the two first inter-assembly nodes; converting the pack charge power to a first battery charge power that is presented from the two first local nodes while in a charge mode; and generating the first control signal with a first controller that varies the first DC-to-DC converter to balance the first state-of-charge with the second state-of-charge while in the discharge mode.

In one or more embodiments, the method includes receiving a second battery discharge power at two second local nodes of a second DC-to-DC converter. The second battery assembly is wired directly to the two second local nodes. The method includes converting the second battery discharge power to the pack discharge power that is presented at two second inter-assembly nodes of the second DC-to-DC converter while in the discharge mode. One of the two second inter-assembly nodes is in communication with a third battery assembly. The third battery assembly has a third state-of-charge. The third battery assembly operates in series with the second battery assembly. The conversion of the second battery discharge power to the pack discharge power varies in response to a second control signal. The method further includes receiving the pack charge power at the two second inter-assembly nodes; converting the pack charge power to a second battery charge power that is presented from the two second local nodes while in the charge mode; and generating the second control signal with a second controller that varies the second DC-to-DC converter to balance the second state-of-charge with the third state-of-charge while in the discharge mode.

In one or more embodiments, the method includes measuring the first state-of-charge of the first battery assembly with a first adaptation module; measuring the second state-of-charge of the second battery assembly; and generating a first target parameter based on the first state-of-charge and the second state-of-charge. The varying of the first DC-to-DC converter is in further response to the first target parameter.

In one or more embodiments, the method includes measuring a feedback voltage at one of the two first inter-assembly nodes. The varying of the first DC-to-DC converter is in further response to the feedback voltage. The first target parameter is a voltage.

In one or more embodiments, the method includes measuring a feedback current flowing from the first battery assembly to the first DC-to-DC converter. The varying of the first DC-to-DC converter is in further response to the feedback current. The first target parameter is a current.

In one or more embodiments of the method, the generating of the first target parameter includes a model predictive control technique based on the first state-of-charge and the second state-of-charge.

In one or more embodiments of the method, the first battery assembly has a different storage capacity than the second battery assembly.

In one or more embodiments of the method, the first battery assembly has a different chemistry than the second battery assembly.

A vehicle is provided herein. The vehicle includes a battery pack and a first controller. The battery pack has a first battery assembly, a second battery assembly, and a first DC-to-DC converter. The first DC-to-DC converter has two first local nodes and two first inter-assembly nodes. The first DC-to-DC converter is operational to: receive a first battery discharge power at the two first local nodes; and convert the first battery discharge power to a pack discharge power that is presented at the two first inter-assembly nodes while in a discharge mode. The conversion of the first battery discharge power to the pack discharge power varies in response to a first control signal. The first DC-to-DC converter is further operational to receive a pack charge power at the two first inter-assembly nodes; and convert the pack charge power to a first battery charge power that is presented from the two first local nodes while in a charge mode. The first battery assembly has a first state-of-charge and is wired directly to the two first local nodes. The second battery assembly has a second state-of-charge, is in communication with one of the two first inter-assembly nodes, and operates in series with the first battery assembly. The first controller is in communication with the first DC-to-DC converter and is operational to generate the first control signal that varies the first DC-to-DC converter to balance the first state-of-charge with the second state-of-charge while in the discharge mode.

In one or more embodiments, the vehicle includes a first adaptation module in communication with the first battery assembly, the second battery assembly, and the first DC-to-DC converter. The first adaptation module is operational to: measure the first state-of-charge of the first battery assembly; measure the second state-of-charge of the second battery assembly; and generate a first target parameter based on the first state-of-charge and the second state-of-charge. The first controller is further operational to vary the first DC-to-DC converter in further response to the first target parameter.

In one or more embodiments of the vehicle, the first adaptation module is further operational to generate the first target parameter with a model predictive control technique based on the first state-of-charge and the second state-of-charge.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram illustrating a context of a system in accordance with one or more exemplary embodiments.

FIG. 2 is a schematic diagram of a state-of-charge mapping in accordance with one or more exemplary embodiments.

FIG. 3 is a schematic block diagram of a first mixed chemistry balancing in accordance with one or more exemplary embodiments.

FIG. 4 is a schematic block diagram of a second mixed chemistry balancing in accordance with one or more exemplary embodiments.

FIG. 5 is a schematic block diagram of a first feedforward set point charging/discharging control in accordance with one or more exemplary embodiments

FIG. 6 is a schematic block diagram of a second feedforward set point charging/discharging control in accordance with one or more exemplary embodiments.

FIG. 7 is a schematic block diagram of an adaptive feed-forward charging/discharging control in accordance with one or more exemplary embodiments.

FIG. 8 is a schematic block diagram of a DC-DC set point control for pack balancing using feedback and model predictive control in accordance with one or more exemplary embodiments.

FIG. 9 is a schematic block diagram of an extended rechargeable energy storage system in accordance with one or more exemplary embodiments.

### DETAILED DESCRIPTION

Mix-chemistry battery packs often include multiple battery assemblies of different chemistries connection in series. The different chemistries result in different battery storage capacities. Embodiments of the disclosure provide one or more variable bi-directional DC-to-DC converters and one or more corresponding controllers coupled with the battery assemblies. The controllers adjust a power conversion through the DC-to-DC converters to allow balancing of states-of-charge among the various battery assemblies during charges and discharges. The balancing enables independent use of the available energies in each battery assembly to maximize ranges of the vehicles. In various embodiments, adaptation modules measure the states-of-charge of the battery assemblies and generate target parameters for the controllers based on the measurements. The controllers subsequently adjust the power throughput of the DC-to-DC converters to help balance the neighboring battery assemblies. In some designs, the battery assemblies may be battery cells. In other designs, the battery assemblies may be battery modules, each with multiple battery cells.

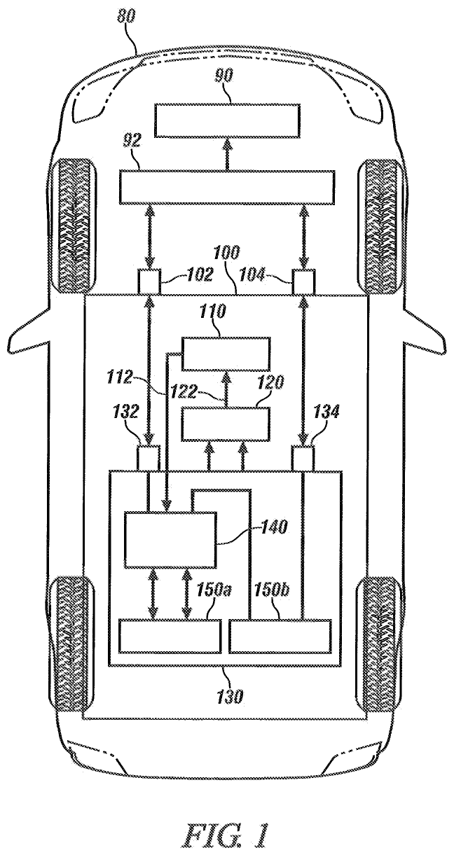

Referring to FIG. 1, a schematic plan diagram illustrating a context of a system is shown in accordance with one or more exemplary embodiments. The system may implement a vehicle 80. The vehicle 80 generally comprises a motor 90, a power controller 92 and a rechargeable energy storage system 100. The rechargeable energy storage system 100 includes one or more controllers 110 (one shown), one or more adaptation modules 120 (one shown) and a battery pack 130. The battery pack 130 includes one or more DC-to-DC converters 140 (one shown) and multiple battery assemblies 150a-150b (two shown).

The vehicle 80 may include, but is not limited to, mobile objects such as automobiles, trucks, motorcycles, boats, trains and/or aircraft. In various embodiments, the vehicle 80 may be an electric vehicle, truck, motorcycle, and the like. In other embodiments, the vehicle 80 may be a hybrid vehicle, truck, motorcycle, and the like. In some embodiments, the vehicle 80 may include stationary objects such as billboards, kiosks, power back-up systems (e.g., uninterruptible power supplies) and/or marquees. Other types of vehicles 80 may be implemented to meet the design criteria of a particular application.

The motor 90 (or individual ones of multiple motors 90) implements an electric motor or a hybrid gas/electric motor. The motor 90 is generally operational to provide rotation and torque to drive wheels of the vehicle 80 to propel the vehicle 80 about the ground and/or roads. The electrical power consumed by the motor 90 may be provided by the rechargeable energy storage system 100 and/or an alternator of the vehicle 80 under the control of the power controller 92.

The power controller 92 implements an electrical power device that exchanges electrical power between the rechargeable energy storage system 100 and the motor 90. The power controller 92 is generally operational to transfer electrical power from an alternator to the rechargeable energy storage system 100 in the charging mode to charge the battery assemblies 150a-150b where the motor 90 includes an internal-combustion engine to run the alternator. The power controller 92 may draw electrical power from the rechargeable energy storage system 100 in the discharge mode. The electrical power received from the rechargeable energy storage system 100 may be used to power the motor 90 and/or other loads within the vehicle 80.

The rechargeable energy storage system 100 implements a high-voltage battery pack configured to store electrical energy. In various embodiments, the rechargeable energy storage system 100 implements a mixed-chemistry battery pack. The rechargeable energy storage system 100 is electrically coupled to the power controller 92. While in a discharge mode, the rechargeable energy storage system 100 is generally operational to discharge by providing electrical power to the motor 90 to move the vehicle 80. While in a charge mode, the rechargeable energy storage system 100 is generally operational to charge by receiving electrical power from the power controller 92 and store the electrical power for later use.

The rechargeable energy storage system 100 includes the multiple battery assemblies 150a-150b electrically connected at least in series between a positive energy system terminal 102 and a negative energy system terminal 104. In various embodiments, the rechargeable energy storage system 100 may provide approximately 200 to 1,000 volts DC (direct current) electrical potential between the positive energy system terminal 102 and the negative energy system terminal 104. Other energy system voltages may be implemented to meet the design criteria of a particular application.

The controller 110 implements a power conversion controller. The controller 110 is electrically coupled to the DC-to-DC converter 140 and to the adaptation module 120. A target parameter signal 122 is received from the adaptation module 120. A control signal 112 is generated by the controller 110 and presented to the DC-to-DC converter 140. The control signal 112 conveys information based on the target parameter signal 122. The control signal 112 determines the extent that the DC-to-DC converter 140 transforms a battery discharge power received from the corresponding battery assembly 150a into a pack discharge power presented to the power controller 92. The control signal 112 may also determine the extent that the DC-to-DC converter 140 transforms a pack charge power received from the power controller 92 into a battery charge power.

Each adaptation module 120 implements a state-of-charge sensing system with feedback to the controller 110 via the target parameter signals 122. Each adaptation module 120 in communication with a corresponding DC-to-DC converter 140 and two neighboring battery assemblies 150a-150b. Each adaptation module 120 is operational to measure battery parameters such as voltage, current and temperature and convert the parameters to a first state-of-charge of a first battery assembly (e.g., 150a), measure a second state-of-charge of a second battery assembly (e.g., 150b), and generate a target parameter in the target parameter signal 122 based on the first state-of-charge and the second state-of-charge.

The battery pack 130 implements a high-voltage battery pack configured to store electrical energy. The battery pack 130 is generally operational to receive electrical power from the power controller 92 while in a charging mode, and provide electrical power to the power controller 92 while in a discharge mode. The battery pack 130 includes at least one DC-to-DC converter 140 and at least two battery assemblies 150a-150b electrically connected in series and/or in parallel between a positive battery pack terminal 132 and a negative battery pack terminal 134. In various embodiments, the battery pack 130 may provide approximately 200 to 1,000 volts DC (direct current) electrical potential between the positive battery pack terminal 132 and the negative battery pack terminal 134. Other battery voltages may be implemented to meet the design criteria of a particular application. The positive battery pack terminal 132 may be electrically connected directly to the positive energy system terminal 102. The negative battery pack terminal 134 may be electrically connected directly to the negative energy system terminal 104.

Each DC-to-DC converter 140 implements a bi-directional, variable power, variable buck/boost voltage converter. The direction of the conversion is controlled by a corresponding controller 110. The conversion of the electrical power during the discharge mode is adjustable through the control signal 112 received from the controller 110. The control signal 112 may convey information that configures the DC-to-DC converter 140 during the discharge mode to vary a rate at which electrical power is drained from a corresponding battery assembly (e.g., 150a as illustrated). The discharge rate may be changed by varying an electrical voltage or electrical current that the DC-to-DC converter 140 contributes to an output voltage of the battery pack 130.

During a charging mode, the control signal 112 conveys information that configured to DC-to-DC converter 140 to vary a rate at which electrical power charges the corresponding battery assembly 150a. The charging rate may be changed by varying an electrical voltage that the DC-to-DC converter 140 contributes to an output voltage of the battery pack 130. The charging rate may be changed by varying an electrical voltage or electrical current that the DC-to-DC converter 140 draws from an input voltage received by the battery pack 130.

Each battery assembly 150a-150b implements one or more battery modules and/or multiple battery cells. Each battery modules generally includes multiple battery cells. Each battery assembly 150a-150b has a corresponding battery assembly type. In various embodiments, the battery assembly type generally includes lithium iron phosphate batteries, lithium iron manganese phosphate batteries, and/or sodium ion batteries. The battery assembly types may have respective battery assembly chemistries including a lithium iron phosphate chemistry, a lithium iron manganese phosphate chemistry, and/or a sodium ion chemistry. Other battery assembly types and/or battery assembly chemistries may be implemented to meet a design criteria of a particular application. In various embodiments, the first battery assembly 150a may have a different battery chemistry than the second battery assembly 150b. In some embodiments, the first battery assembly 150a may have a different storage capacity than the second battery assembly 150b.

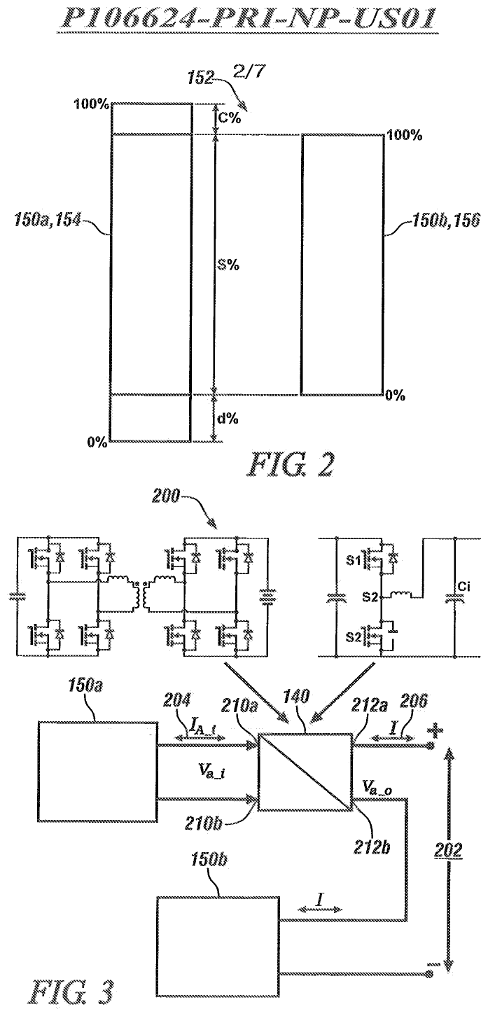

Referring to FIG. 2, a schematic diagram of an example state-of-charge mapping 152 is shown in accordance with one or more exemplary embodiments. The state-of-charge mapping 152 illustrates a first state-of-charge 154 (SOC_{A}) of the first battery assembly 150a relative to a second state-of-charge 156 (SOC_{B}) of a second battery assembly 150b having a different battery chemistry and/or a different storage capacity as first the battery assembly 150a. By way of example, the first battery assembly 150a may have a nickel cobalt manganese (NCM) chemistry and a first storage capacity CAP_{A}. The second battery assembly 150b may have a lithium iron phosphate (LFP) chemistry and a second storage capacity CAP_{B}. The first storage capacity CAP_{A} is related to the second storage capacity CAP_{B} by equation 1 as follows:

$${CAP}_{A} = ( 1 \; 00 \% / S \% ) \times {CAP}_{B} \qquad Eq . ( 1 )$$

Where S % is a percentage of the first storage capacity CAP_{A} that spans the full second storage capacity CAP_{B} (e.g., from 0% state-of-charge to 100% state-of-charge).

The first battery assembly 150a has the first state-of-charge 154 at a measurement (or observation) time k, 154=SOC_{A} (k). The second battery assembly 150b has the second state-of-charge 156 at the measurement (or observation) time k, 156=SOC_{B} (k). The first SOC_{A} is related to the second SOC_{B} by equation 2 as follows:

$${SOC}_{A} ( k ) = ( ( {CAP}_{B} / {CAP}_{A} ) \times {SOC}_{B} ( k ) ) + d \% \qquad Eq . ( 2 )$$

Where d % is a percentage of the first storage capacity CAP_{A} that spans a zero-value first state-of-charge SOC_{A} to a zero-value second state-of charge SOC_{B}.

By adjusting a discharge current/charging current from/to the first battery assembly 150a and the second battery assembly 150b based on the ratio of the second storage capacity CAP_{B} to the first storage capacity CAP_{A}, the first state-of-charge SOC_{A}(k) may be kept approximately in balance with the second state-of-charge SOC_{B}(k) at each time k. Thus the first battery assembly 150a and the second battery assembly 150b may approach the 100% state-of-charge together during a recharge, and approach the 0% state-of-charge together during a discharge. The concurrent approach to the 0% state-of-charge extends a range of the vehicle 80 compared with one battery assembly reaching the 0% state-of-charge while the other battery assembly still has a usable charge.

The controller 110 generally balances the states-of-charge such that SOC_{A}=SOC_{B}. The balance may be achieved per equation 3 and equation 4 as follows:

$$\frac{\int {i}_{a\_i} dt}{CAPa} = \frac{\int Idt}{CAPb} \qquad Eq . ( 3 )$$

$${i}_{a\_i} = \frac{CAPa \cdot I}{CAPb} \qquad Eq . ( 4 )$$

Referring to FIG. 3 with reference back to FIG. 1, a schematic block diagram of an example first mixed chemistry balancing 200 is shown in accordance with one or more exemplary embodiments. Example implementations of the DC-to-DC converter 140 are also illustrated. In the first mixed chemistry balancing 200, the first battery assembly 150a has a lower storage capacity than the second battery assembly 150b. The DC-to-DC converter 140 includes two first local nodes 210a-210b that are directly connected to the first battery assembly 150a. The DC-to-DC converter 140 includes two first inter-assembly nodes 212a-212b, one node (e.g., 212b) is connected in series to the second battery assembly 150b.

During the discharge mode, the DC-to-DC converter 140 may be configured to discharge the lower storage capacity (e.g., LFP chemistry) first battery assembly 150a at a slower rate than the higher storage capacity (e.g., NCM chemistry) second battery assembly 150b is discharged. The discharging generates a pack voltage 202 as measured from the positive battery pack terminal 132 to the negative battery pack terminal 134. A first discharge current 204 from the first battery assembly 150a is generally smaller than a second discharge current 206 from the second battery assembly 150b. During the charging mode, the DC-to-DC converter 140 may be configured to charge the lower storage capacity first battery assembly 150a at a slower rate than the higher storage capacity second battery assembly 150b is charged.

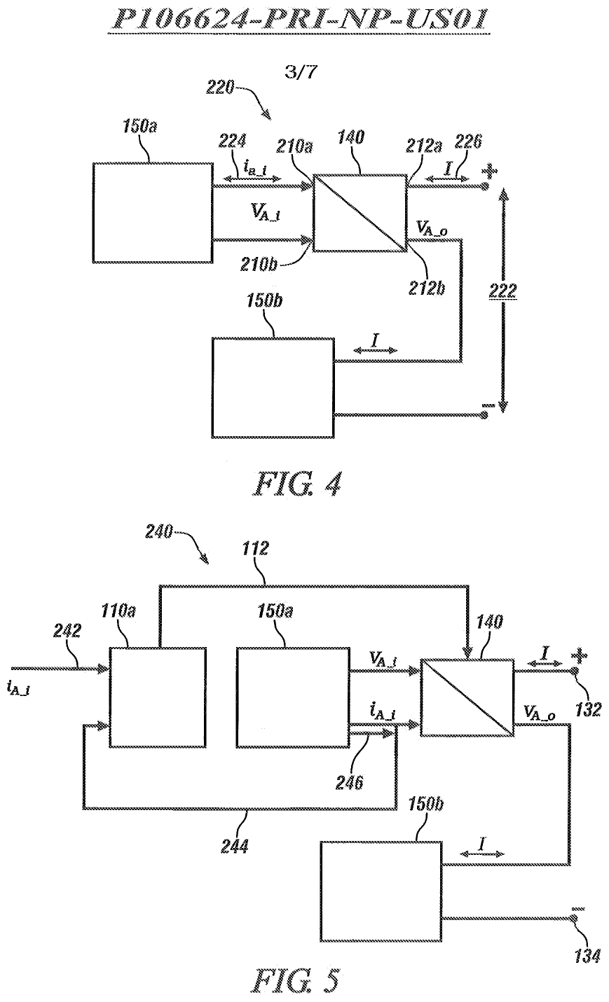

Referring to FIG. 4 with reference back to FIG. 1, a schematic block diagram of an example second mixed chemistry balancing 220 is shown in accordance with one or more exemplary embodiments. In the second mixed chemistry balancing 220, the first battery assembly 150a has a higher storage capacity (e.g., NCM chemistry) than the second battery assembly 150b (e.g., LFP chemistry). The two local modes 210a-210b of the DC-to-DC converter 140 are directly connected to the first battery assembly 150a. One of the two inter-assembly nodes 212a-212b is connected in series with the second battery assembly 150b.

During the discharge mode, the DC-to-DC converter 140 may be configured to discharge the higher storage capacity first battery assembly 150a faster than the lower storage capacity second battery assembly 150b is discharged. The discharging generates a pack voltage 222 as measured from the positive battery pack terminal 132 to the negative battery pack terminal 134. A third discharge current 224 from the first battery assembly 150a is generally larger than a fourth discharge current 226 from the second battery assembly 150b. During the charging mode, the DC-to-DC converter 140 may be configured to charge the higher storage capacity first battery assembly 150a at a faster rate than the lower storage capacity second battery assembly 150b is charged.

Referring to FIG. 5 with reference back to FIGS. 1 and 3, a schematic block diagram of an example first feedforward set point charging/discharging control 240 is shown in accordance with one or more exemplary embodiments. The first feedforward set point charging/discharging control 240 provides a first feedforward target current signal 242 to a first controller 110a. The first controller 110a is a variation of the controller 110. A first feedback signal 244 carries a current value of a feedback current 246 between the first battery assembly 150a and the DC-to-DC converter 140. The first feedback signal 244 is received by the first controller 110a.

The first controller 110a is operational to generate the control signal 112 based on both the first feedforward target current signal 242 and the current value in the first feedback signal 244. The first feedforward target current signal 242 carries the target parameter that defines the ratio of the two storage capacities CAP_{A} and CAP_{B} for the first controller 110a.

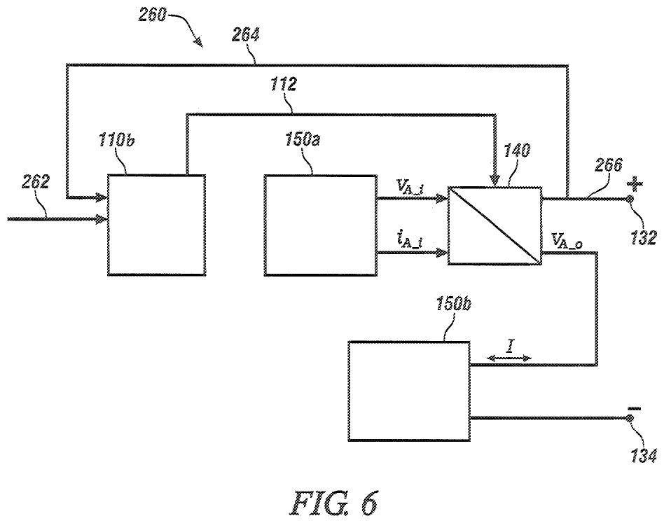

Referring to FIG. 6 with reference back to FIGS. 1 and 3, a schematic block diagram of an example second feedforward set point charging/discharging control 260 is shown in accordance with one or more exemplary embodiments. The second feedforward set point charging/discharging control 260 provides a second feedforward target voltage signal 262 to a second controller 110b. The second controller 110b is a variation of the controller 110. A second feedback signal 264 carries a voltage value of a feedback voltage 266 at an inter-assembly node of the DC-to-DC converter 140. The second feedback signal 264 is received by the second controller 110b.

The second controller 110b is operational to generate the control signal 112 based on both the second feedforward target voltage signal 262 and the voltage value in the second feedback signal 264. The second feedforward target voltage signal 262 carries the target parameter that defines the ratio of the two storage capacities CAP_{A} and CAP_{B} for the second controller 110b.

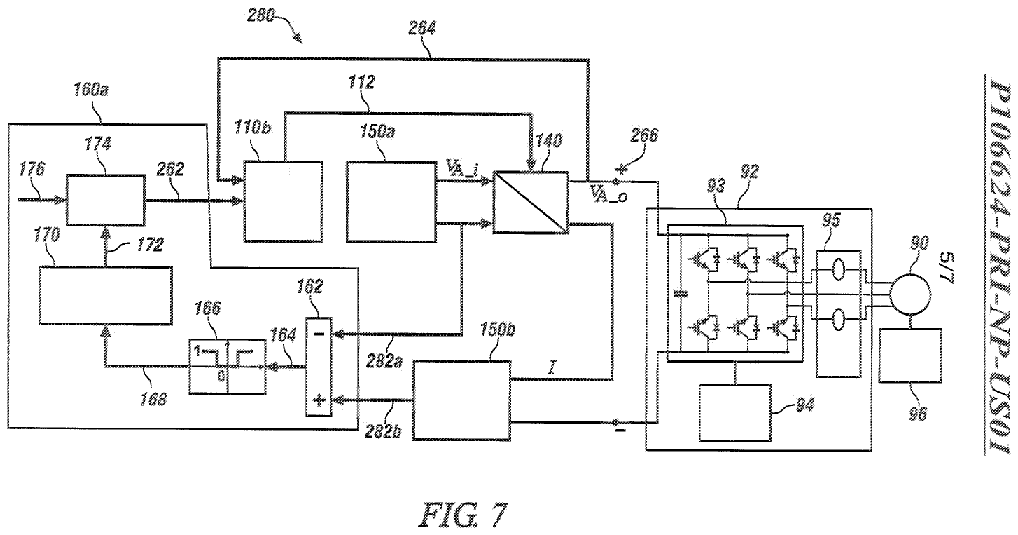

Referring to FIG. 7 with reference back to FIGS. 1 and 6, a schematic block diagram of an example adaptive feed-forward charging/discharging control 280 is shown in accordance with one or more exemplary embodiments. The adaptive feed-forward charging/discharging control 280 provides the second controller 110b, the DC-to-DC converter 140, the first battery assembly 150a, the second battery assembly 150b, and a first adaption module 160a. The modules described herein may be implemented in hardware and/or software executed by hardware. The second feedforward target voltage signal 262 to the second controller 110b. The second feedback signal 264 carries the voltage value of the feedback voltage 266 at the inter-assembly node of the DC-to-DC converter 140. The second feedback signal 264 is received by the second controller 110b.

The power controller 92 may include a three-phase DC-to-AC converter circuit 93, a Linear Parameter Varying-Model Predictive Control (LPV/MPC) technique or a Linear Time Varying-Model Predictive Control (LTV/MPC) technique circuit 94, multiple AC current feedback sensors 95 of the three-phase currents that driver the motor 90, and motor speed and position sensors 96. The Model predictive control technique is a control technique where a calculated control action minimizes a cost function for a constrained dynamical system.

The first adaption module 160a includes a comparator 162, a register 166, a gamma adaptation module 170, and a first ratio adjustment module 174. The first adaption module 160a receives a first state-of-charge signal 282a from the first battery assembly 150a and a second state-of-charge signal 282b from the second battery assembly 150b. A filter voltage signal 176 is received by the first ratio adjustment module 174. The second feedforward target voltage signal 262 is generated by the first ratio adjustment module 174.

The comparator 162 compares a first SOC_{A} in the first state-of-charge signal 282a with second SOC_{B} in the second state-of-charge signal 282b to produce a logical one value (or high value) or a logical zero value (or low value), depending on whichever state-of-charge is greater, in a compare signal 164. An efficiency of the adaptation may be effective at a quasi-steady state. Therefore, the logical one value/logical zero value is periodically stored in the register 166.

The gamma adaptation module 170 generates a gamma value in a gamma signal 172 based on the logical value (read from the register 166 in a read signal 168), the first SOC_{A}, and the second SOC_{B}. The gamma value (γ) is generated by equation 5 as follows:

$$γ = {SOC}_{A} / {SOC}_{B} \qquad Eq . ( 5 )$$

The first ratio adjustment module 174 is operational to generate the second feedforward target voltage signal 262 based on the first storage capacity CAP_{A}, the second storage capacity CAP_{B}, the gamma value γ, and a filter constant voltage V_{F}. The filter constant voltage V_{F} may be calibrated based on a DC-DC response time constant of the system. The second feedforward target voltage signal 262 may be calculated by equation 6 as follows:

$$Target voltage = γ \times ( {CAP}_{A} / {CAP}_{B} ) \times {V}_{F} \qquad Eq . ( 6 )$$

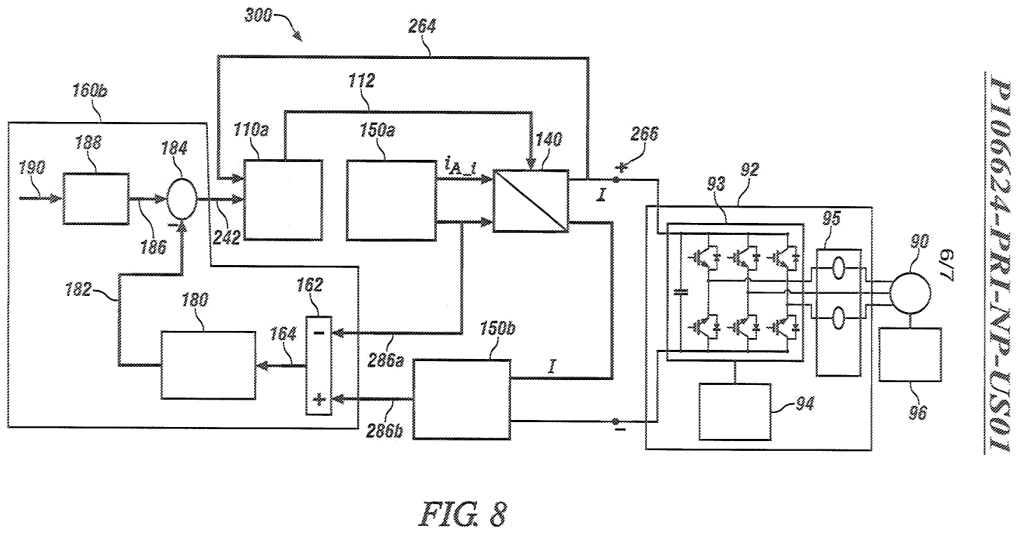

Referring to FIG. 8 with reference back to FIGS. 1 and 5, a schematic block diagram of an example DC-DC set point control for pack balancing using feedback and model predictive control 300 is shown in accordance with one or more exemplary embodiments. The DC-DC set point control for pack balancing using feedback and model predictive control 300 provides the first controller 110a, the DC-to-DC converter 140, the first battery assembly 150a, the second battery assembly 150b, and a second adaptation module 160b.

The first feedforward target current signal 242 is transferred to the first controller 110a. The second feedback signal 264 carries the voltage value of the feedback voltage 266 at the inter-assembly node of the DC-to-DC converter 140. The second feedback signal 264 is received by the first controller 110a.

The power control 92 may include the three-phase DC-to-AC converter circuit 93, the Linear Parameter Varying-Model Predictive Control (LPV/MPC) technique or the Linear Time Varying-Model Predictive Control (LTV/MPC) technique circuit 94, multiple AC current feedback sensors 95 of the three-phase currents that driver the motor 90, and the motor speed and position sensors 96.

A second adaption module 160b includes the comparator 162, a gain scheduling or model predictive control (MPC) module 180, a subtraction module 184, and a second ratio adjustment module 188. The comparator 162 compares the first SOC_{A} in a third state-of-charge signal 286a with the second SOC_{B} in a fourth state-of-charge signal 286b. The gain scheduling or model predictive control module 180 generates a feedback signal 182 based on the compare signal 164.

The second ratio adjustment module 188 generates a ratio signal 186 based on a filter current signal 190. The feedback signal 182 is subtracted from ratio signal 186 by the subtraction module 184 to generate the first feedforward target current signal 242. The second ratio adjustment module 188 is operational to generate the ratio signal 186 based on a filter constant current V_{I}. The filter constant current V_{I} may be calibrated based on a DC-DC response time constant.

A cost function of the model predictive control module 180 is given in equation 7 as follows:

$$J = {\sum }_{k = 1}^{N} {( {SOC}_{B} ( k ) - {SOC}_{B} ( k ) )}^{2} + c Δ {i}_{A\_i}^{2} \qquad Eq . ( 7 )$$

Changes in the state-of-charge of the first battery assembly 150a from a time k to a time k+1 may be modeled by equation 8 as follows:

$${SOC}_{A} ( k + 1 ) = {SOC}_{A} ( k ) + \frac{Δ {i}_{A\_i}}{{CAP}_{A}} \qquad Eq . ( 8 )$$

Where Δₘᵢₙ<Δi_{A_i}<Δₘₐₓ

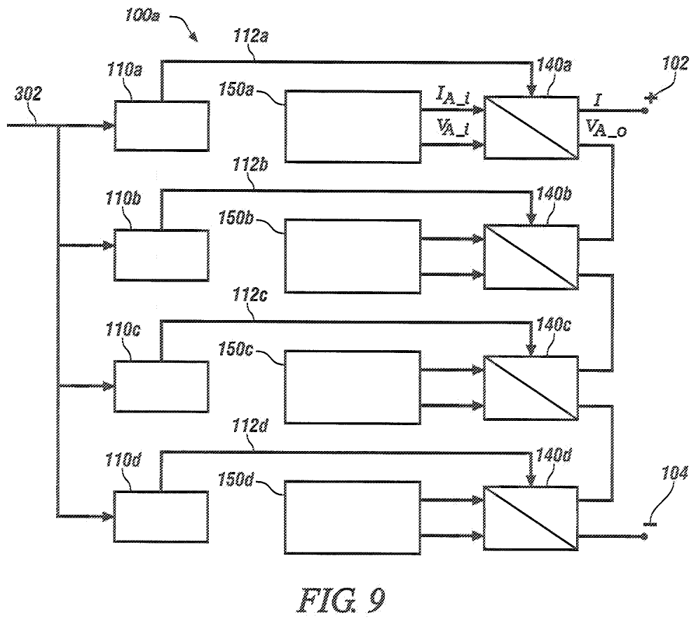

Referring to FIG. 9 with reference back to FIG. 1, a schematic block diagram of an example extended rechargeable energy storage system 100a is shown in accordance with one or more exemplary embodiments. The extended rechargeable energy storage system 100a is a variation of the rechargeable energy storage system 100 with multiple controllers 110a-110d, multiple battery assemblies 150a-150d, and multiple DC-to-DC converters 140a-140d wired in series between the positive energy system terminal 102 and the negative energy system terminal 104.

The active battery state-of-charge balancing technique may be extended to account for the multiple battery assemblies 150a-150d with common chemistry or mixed-chemistry of different storage capacities. For example, a first controller 110a may control a first DC-to-DC converter 140a with a first control signal 112a to balance the states-of-charge between a first battery assembly 150a and a second battery assembly 150b. A second controller 110b may control a second DC-to-DC converter 140b with a second control signal 112b to balance the states-of-charge between the second battery assembly 150b and a third battery assembly 150c. A third controller 110c may control a third DC-to-DC converter 140c with a third control signal 112c to balance the states-of-charge between the third battery assembly 150c and a fourth battery assembly 150d. A fourth controller 110d may control a fourth DC-to-DC converter 140d with a fourth control signal 112d to balance the states-of-charge between the fourth battery assembly 150d and a fifth battery assembly, and so on.

A dominant battery assembly 150a-150d may be chosen to establish a reference target set point control 302 with a target parameter (e.g., a target voltage or a target current). The dominant battery assembly 150a-150d may be either a smallest storage capacity or a largest storage capacity among the battery assemblies 150a-150d. The balancing technique is conducted at selected SOC intervals and targeting a final minimum SOC points, [SOC_min(i), SOC_max(i)], i=1 to n battery assemblies.

Embodiments of the rechargeable energy storage system use buck/boost DC-to-DC converters to balance the states-of-charge in mix-chemistry battery assemblies to maximize a drivable range of a vehicle. In various embodiments, the DC-to-DC converters may be integrated with feedforward current/voltage regulations to balance the battery assembly states-of-charge. Some embodiments may include feedforward and adaptation regulation of DC-to-DC current/voltages to balance the battery assembly states-of-charge. In still other embodiments, feedforward and module predictive control of the DC-to-DC converters is used to balance the battery assembly states-of-charge.

Embodiments of the rechargeable energy storage system allow for low cost design and high energy density to maximize vehicle range through smart battery management.

Numerical values of parameters (e.g., of quantities or conditions) in this specification, including the appended claims, are to be understood as being modified in instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A rechargeable energy storage system comprising:
a first DC-to-DC converter having two first local nodes and two first inter-assembly nodes, and the first DC-to-DC converter is operational to:
receive a first battery discharge power at the two first local nodes;
convert the first battery discharge power to a pack discharge power that is presented at the two first inter-assembly nodes while in a discharge mode, wherein the conversion of the first battery discharge power to the pack discharge power varies in response to a first control signal;
receive a pack charge power at the two first inter-assembly nodes; and
convert the pack charge power to a first battery charge power that is presented from the two first local nodes while in a charge mode;
a first battery assembly having a first state-of-charge and wired directly to the two first local nodes;
a second battery assembly having a second state-of-charge, in communication with one of the two first inter-assembly nodes, and operates in series with the first battery assembly; and
a first controller in communication with the first DC-to-DC converter and operational to generate the first control signal that varies the first DC-to-DC converter to balance the first state-of-charge with the second state-of-charge while in the discharge mode.

2. The rechargeable energy storage system according to claim 1, further comprising:
a second DC-to-DC converter having two second local nodes and two second inter-assembly nodes, and the second DC-to-DC converter is operational to:
receive a second battery discharge power at the two second local nodes, wherein the second battery assembly is wired directly to the two second local nodes;
convert the second battery discharge power to the pack discharge power that is presented at the two second inter-assembly nodes while in the discharge mode, wherein the conversion of the second battery discharge power to the pack discharge power varies in response to a second control signal;
receive the pack charge power at the two second inter-assembly nodes; and
convert the pack charge power to a second battery charge power that is presented from the two second local nodes while in the charge mode;
a third battery assembly having a third state-of-charge, in communication with one of the two second inter-assembly nodes, and operates in series with the second battery assembly; and
a second controller in communication with the second DC-to-DC converter and operational to generate the second control signal that varies the second DC-to-DC converter to balance the second state-of-charge with the third state-of-charge while in the discharge mode.

3. The rechargeable energy storage system according to claim 1, further comprising:
a first adaptation module in communication with the first battery assembly, the second battery assembly, and the first DC-to-DC converter, wherein the first adaptation module is operational to:
measure the first state-of-charge of the first battery assembly;
measure the second state-of-charge of the second battery assembly; and
generate a first target parameter based on the first state-of-charge and the second state-of-charge,
wherein the first controller is further operational to vary the first DC-to-DC converter in further response to the first target parameter.

4. The rechargeable energy storage system according to claim 3, wherein:
the first controller is further operational to:
measure a feedback voltage at one of the two first inter-assembly nodes; and
vary the first DC-to-DC converter in further response to the feedback voltage; and
the first target parameter is a voltage.

5. The rechargeable energy storage system according to claim 3, wherein:
the first controller is further operational to:
measure a feedback current flowing from the first battery assembly to the first DC-to-DC converter; and
vary the first DC-to-DC converter in further response to the feedback current; and
the first target parameter is a current.

6. The rechargeable energy storage system according to claim 3, wherein the first adaptation module is further operational to generate the first target parameter with a model predictive control technique based on the first state-of-charge and the second state-of-charge.

7. The rechargeable energy storage system according to claim 1, wherein the first battery assembly has a different storage capacity than the second battery assembly.

8. The rechargeable energy storage system according to claim 1, wherein the first battery assembly has a different chemistry than the second battery assembly.

9. The rechargeable energy storage system according to claim 1, wherein the first battery assembly and the second battery assembly form part of a vehicle.

10. A method for active battery state-of-charge balancing comprising:
receiving a first battery discharge power from a first battery assembly at two first local nodes of a first DC-to-DC converter, wherein the first battery assembly has a first state-of-charge and is wired directly to the two first local nodes;
converting the first battery discharge power to a pack discharge power that is presented at two first inter-assembly nodes of the first DC-to-DC converter while in a discharge mode, wherein:
one of the two first inter-assembly nodes is in communication with a second battery assembly;
the second battery assembly has a second state-of-charge;
the second battery assembly operates in series with the first battery assembly; and
the converting of the first battery discharge power to the pack discharge power varies in response to a first control signal;
receiving a pack charge power at the two first inter-assembly nodes;
converting the pack charge power to a first battery charge power that is presented from the two first local nodes while in a charge mode; and
generating the first control signal with a first controller that varies the first DC-to-DC converter to balance the first state-of-charge with the second state-of-charge while in the discharge mode.

11. The method according to claim 10, further comprising:
receiving a second battery discharge power at two second local nodes of a second DC-to-DC converter, wherein the second battery assembly is wired directly to the two second local nodes;
converting the second battery discharge power to the pack discharge power that is presented at two second inter-assembly nodes of the second DC-to-DC converter while in the discharge mode, wherein:
one of the two second inter-assembly nodes is in communication with a third battery assembly;
the third battery assembly has a third state-of-charge;
third battery assembly operates in series with the second battery assembly; and
the conversion of the second battery discharge power to the pack discharge power varies in response to a second control signal;
receiving the pack charge power at the two second inter-assembly nodes;
converting the pack charge power to a second battery charge power that is presented from the two second local nodes while in the charge mode; and
generating the second control signal with a second controller that varies the second DC-to-DC converter to balance the second state-of-charge with the third state-of-charge while in the discharge mode.

12. The method according to claim 10, further comprising:
measuring the first state-of-charge of the first battery assembly with a first adaptation module;
measuring the second state-of-charge of the second battery assembly; and
generating a first target parameter based on the first state-of-charge and the second state-of-charge,
wherein the varying of the first DC-to-DC converter is in further response to the first target parameter.

13. The method according to claim 12, further comprising:
measuring a feedback voltage at one of the two first inter-assembly nodes, wherein:
the varying of the first DC-to-DC converter is in further response to the feedback voltage; and
the first target parameter is a voltage.

14. The method according to claim 12, further comprising:
measuring a feedback current flowing from the first battery assembly to the first DC-to-DC converter, wherein
the varying of the first DC-to-DC converter is in further response to the feedback current; and
the first target parameter is a current.

15. The method according to claim 12, wherein the generating of the first target parameter includes a model predictive control technique based on the first state-of-charge and the second state-of-charge.

16. The method according to claim 10, wherein the first battery assembly has a different storage capacity than the second battery assembly.

17. The method according to claim 10, wherein the first battery assembly has a different chemistry than the second battery assembly.

18. A vehicle comprising:
a battery pack having a first battery assembly, a second battery assembly, and a first DC-to-DC converter, wherein:
the first DC-to-DC converter has two first local nodes and two first inter-assembly nodes, and the first DC-to-DC converter is operational to:
receive a first battery discharge power at the two first local nodes;
convert the first battery discharge power to a pack discharge power that is presented at the two first inter-assembly nodes while in a discharge mode, wherein the conversion of the first battery discharge power to the pack discharge power varies in response to a first control signal;
receive a pack charge power at the two first inter-assembly nodes; and
convert the pack charge power to a first battery charge power that is presented from the two first local nodes while in a charge mode;
the first battery assembly has a first state-of-charge and is wired directly to the two first local nodes;
the second battery assembly has a second state-of-charge, is in communication with one of the two first inter-assembly nodes, and operates in series with the first battery assembly; and
a first controller in communication with the first DC-to-DC converter and operational to generate the first control signal that varies the first DC-to-DC converter to balance the first state-of-charge with the second state-of-charge while in the discharge mode.

19. The vehicle according to claim 18, further comprising:
a first adaptation module in communication with the first battery assembly, the second battery assembly, and the first DC-to-DC converter, wherein the first adaptation module is operational to:
measure the first state-of-charge of the first battery assembly;
measure the second state-of-charge of the second battery assembly; and
generate a first target parameter based on the first state-of-charge and the second state-of-charge,
wherein the first controller is further operational to vary the first DC-to-DC converter in further response to the first target parameter.

20. The vehicle according to claim 19, wherein the first adaptation module is further operational to generate the first target parameter with a model predictive control technique based on the first state-of-charge and the second state-of-charge.
